(19) United States
(12) Patent Application Publication
(10) Pub. No.: US 2022/0195337 A1
(43) Pub. Date: Jun. 23, 2022

(54) LAUNDRY COMPOSITION

(71) Applicant: Conopco, Inc., d/b/a UNILEVER, Englewood Cliffs, NJ (US)

(72) Inventors: Karl BURGESS, Prenton, Wirral (GB); Andrew Peter ROSE, Wirral (GB)

(73) Assignee: Conopco, Inc., d/b/a UNILEVER, Englewood Cliffs, NJ (US)

(21) Appl. No.: 17/610,079

(22) PCT Filed: May 13, 2020
(86) PCT No.: PCT/EP2020/063325

§ 371 Date: Nov. 9, 2021

(30) Foreign Application Priority Data
May 16, 2019 (EP) 19174844.1

(51) Int. Cl. C11D 3/00; C11D 11/00; C11D 1/72; C11D 3/386; C11D 3/50

(52) U.S. Cl. CPC C11D 3/0015; C11D 11/0017; C11D 3/505; C11D 3/38645; C11D 1/72

(57) ABSTRACT

The present invention relates to a rinse added ancillary laundry composition, for improving the softening effect of a fabric conditioner, the ancillary laundry composition comprising: a. Cellulase; b. 0.5-12 wt. % non-ionic surfactant; c. 0.5 to 20 wt. % free perfume; and d. Water.

### FIELD OF THE INVENTION

The present invention relates to an ancillary laundry composition comprising enzymes.

### BACKGROUND OF THE INVENTION

Consumers are becoming more environmentally conscious. Awareness of issues such as fast fashion is growing, as is the desire to prevent waste fabrics and to avoid prematurely throwing clothes away.

Consumers are looking to laundry products to aid in prolonging the life of clothes. Fabric conditioners provide some benefits, such as softening, however there remains a need to provide formulations which help in prolonging of the life of clothes.

The inventors of the present invention have found that the compositions and methods of the present invention improve the softening effect of fabric conditioners, providing the feel of newer clothes.

### SUMMARY OF THE INVENTION

In a first aspect of the present invention is provided a rinse added ancillary laundry composition, for improving the softening effect of a fabric conditioner, the ancillary laundry composition comprising:
a. Cellulase;
b. 0.5-12 wt. % non-ionic surfactant;
c. 0.5 to 20 wt. % free perfume; and
d. Water.

In a second aspect of the present invention is provided a method of delivering enzymes to fabrics during the rinse stage of the laundry cycle, wherein the ancillary laundry composition as described herein, is added to the rinse, in addition to a fabric conditioner formulation.

In a third aspect of the present invention is provided a method of improving the softening benefit of a fabric conditioner, wherein the ancillary laundry composition as described herein, is added to the rinse, in addition to a fabric conditioner formulation.

In a forth aspect of the present invention is provided a use of an ancillary laundry composition as described herein, to deliver enzymes to fabrics in the rinse stage of the laundry cycle.

In a fifth aspect of the present invention is provided a use of an ancillary laundry composition as described herein, to improve the softening benefit of a fabric conditioner.

### DETAILED DESCRIPTION OF THE INVENTION

These and other aspects, features and advantages will become apparent to those of ordinary skill in the art from a reading of the following detailed description and the appended claims. For the avoidance of doubt, any feature of one aspect of the present invention may be utilised in any other aspect of the invention. The word “comprising” is intended to mean “including” but not necessarily “consisting of” or “composed of.” In other words, the listed steps or options need not be exhaustive. It is noted that the examples given in the description below are intended to clarify the invention and are not intended to limit the invention to those examples per se. Similarly, all percentages are weight/weight percentages unless otherwise indicated. Except in the operating and comparative examples, or where otherwise explicitly indicated, all numbers in this description indicating amounts of material or conditions of reaction, physical properties of materials and/or use are to be understood as modified by the word “about”. Numerical ranges expressed in the format “from x to y” are understood to include x and y. When for a specific feature multiple preferred ranges are described in the format “from x to y”, it is understood that all ranges combining the different endpoints are also contemplated.

Form of the Invention

The term ‘ancillary laundry composition’ is used to refer to a specific format of laundry product. This is a liquid product which is intended to be used in addition to a laundry detergent and/or the fabric conditioner to provide an additional or improved benefit to the materials in the wash or rinse cycle. However, the formulations may be used instead of a fabric conditioner formulation. Ancillary laundry compositions may also be referred to as a serum.

This particular format provides an improved benefit delivery. It also provides consumers with a simple additive product which can be used it addition to their usual fabric conditioner.

Enzymes

The ancillary laundry compositions of the present invention comprise at least a cellulase enzyme. Other enzymes may be present, these enzymes may be selected from: proteases, alpha-amylases, lipases, peroxidases/oxidases, pectate lyases, and mannanases, or mixtures thereof. Preferably the other enzymes are selected from protease, lipase, amylase and mixtures thereof.

Each class of enzyme present in the ancillary laundry composition of present invention is present in a level of from 0.0001 wt. % to 0.1 wt. % of the composition. For example, if the composition comprises cellulase and amylase, the composition will comprise 0.0001 wt. % to 0.1 wt. % cellulase and 0.0001 wt. % to 0.1 wt. % amylase.

The amount of each enzyme present in the ancillary laundry composition is particularly important since this is a rinse added formulation. Enough enzyme is required provide a benefit in the short rinse cycle. However, some of the enzymes will be deposited onto the washed fabric and stay on the fabric during use, therefore it is important not to have too much enzyme.

Levels of enzyme present in the composition preferably relate to the level of enzyme as pure protein.

Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g. the fungal cellulases produced from Humicola insolens, Thielavia terrestris, Myceliophthora thermophila, and Fusarium oxysporum disclosed in U.S. Pat. Nos. 4,435,307, 5,648,263, 5,691,178, 5,776,757, WO 89/09259, WO 96/029397, and WO 98/012307. Commercially available cellulases include Celluzyme™, Carezyme™, Celluclean™, Endolase™, Renozyme™ (Novozymes A/S), Clazinase™ and Puradax HA™ (Genencor International Inc.), and KAC-500(B)™ (Kao Corporation). Celluclean™ is preferred.

Suitable lipases include those of bacterial or fungal origin. Chemically modified or protein engineered mutants are included. Examples of useful lipases include lipases from Humicola (synonym Thermomyces), e.g. from H. lanuginosa (T. lanuginosus) as described in EP 258 068 and EP 305 216 or from H. insolens as described in WO 96/13580, a Pseudomonas lipase, e.g. from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), a Bacillus lipase, e.g. from B. subtilis (Dartois et al. (1993), Biochemica et Biophysica Acta, 1131, 253-360), B. stearothermophilus (JP 64/744992) or B. pumilus (WO 91/16422). Other examples are lipase variants such as those described in WO 92/05249, WO 94/01541, EP 407 225, EP 260 105, WO 95/35381, WO 96/00292, WO 95/30744, WO 94/25578, WO 95/14783, WO 95/22615, WO 97/04079 and WO 97/07202, WO 00/60063.

Preferred commercially available lipase enzymes include Lipolase™ and Lipolase Ultra™, Lipex™ and Lipoclean™ (Novozymes A/S).

The invention may be carried out in the presence of phospholipase classified as EC 3.1.1.4 and/or EC 3.1.1.32. As used herein, the term phospholipase is an enzyme which has activity towards phospholipids.

Phospholipids, such as lecithin or phosphatidylcholine, consist of glycerol esterified with two fatty acids in an outer (sn-1) and the middle (sn-2) positions and esterified with phosphoric acid in the third position; the phosphoric acid, in turn, may be esterified to an amino-alcohol. Phospholipases are enzymes which participate in the hydrolysis of phospholipids. Several types of phospholipase activity can be distinguished, including phospholipases A₁ and A₂ which hydrolyze one fatty acyl group (in the sn-1 and sn-2 position, respectively) to form lysophospholipid; and lysophospholipase (or phospholipase B) which can hydrolyze the remaining fatty acyl group in lysophospholipid. Phospholipase C and phospholipase D (phosphodiesterases) release diacyl glycerol or phosphatidic acid respectively.

Protease enzymes hydrolyse bonds within peptides and proteins, in the laundry context this leads to enhanced removal of protein or peptide containing stains. Examples of suitable proteases families include aspartic proteases; cysteine proteases; glutamic proteases; aspargine peptide lyase; serine proteases and threonine proteases. Such protease families are described in the MEROPS peptidase database (http://merops.sanger.ac.uk/). Serine proteases are preferred. Subtilase type serine proteases are more preferred. The term “subtilases” refers to a sub-group of serine protease according to Siezen et al., Protein Engng. 4 (1991) 719-737 and Siezen et al. Protein Science 6 (1997) 501-523. Serine proteases are a subgroup of proteases characterized by having a serine in the active site, which forms a covalent adduct with the substrate. The subtilases may be divided into 6 sub-divisions, i.e. the Subtilisin family, the Thermitase family, the Proteinase K family, the Lantibiotic peptidase family, the Kexin family and the Pyrolysin family.

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO 89/06279 and protease PD138 described in (WO 93/18140). Other useful proteases may be those described in WO 92/175177, WO 01/016285, WO 02/026024 and WO 02/016547. Examples of trypsin-like proteases are trypsin (e.g. of porcine or bovine origin) and the Fusarium protease described in WO 89/06270, WO 94/25583 and WO 05/040372, and the chymotrypsin proteases derived from Cellumonas described in WO 05/052161 and WO 05/052146.

Most preferably the protease is a subtilisins (EC 3.4.21.62).

Examples of subtilases are those derived from Bacillus such as Bacillus lentus, B. alkalophilus, B. subtilis, B. amyloliquefaciens, Bacillus pumilus and Bacillus gibsonii described in; U.S. Pat. No. 7,262,042 and WO09/021867, and subtilisin lentus, subtilisin Novo, subtilisin Carlsberg, Bacillus licheniformis, subtilisin BPN′, subtilisin 309, subtilisin 147 and subtilisin 168 described in WO89/06279 and protease PD138 described in (WO93/18140). Preferably the subsilisin is derived from Bacillus, preferably Bacillus lentus, B. alkalophilus, B. subtilis, B. amyloliquefaciens, Bacillus pumilus and Bacillus gibsonii as described in U.S. Pat. No. 6,312,936 BI, U.S. Pat. Nos. 5,679,630, 4,760,025, 7,262,042 and WO 09/021867. Most preferably the subtilisin is derived from Bacillus gibsonii or Bacillus Lentus.

Suitable commercially available protease enzymes include those sold under the trade names names Alcalase®, Blaze®; Duralase™, Durazym™, Relase®, Relase® Ultra, Savinase®, Savinase® Ultra, Primase®, Polarzyme®, Kannase®, Liquanase®, Liquanase® Ultra, Ovozyme®, Coronase®, Coronase® Ultra, Neutrase®, Everlase® and Esperase® all could be sold as Ultra® or Evity® (Novozymes A/S).

The invention may use cutinase, classified in EC 3.1.1.74. The cutinase used according to the invention may be of any origin. Preferably cutinases are of microbial origin, in particular of bacterial, of fungal or of yeast origin.

Suitable amylases (alpha and/or beta) include those of bacterial or fungal origin. Chemically modified or protein engineered mutants are included. Amylases include, for example, alpha-amylases obtained from Bacillus, e.g. a special strain of B. licheniformis, described in more detail in GB 1,296,839, or the Bacillus sp. strains disclosed in WO 95/026397 or WO 00/060060. Commercially available amylases are Duramyl™′ Termamyl™, Termamyl Ultra™, Natalase™, Stainzyme™, Fungamyl™ and BAN™ (Novozymes A/S), Rapidase™ and Purastar™ (from Genencor International Inc.).

Suitable peroxidases/oxidases include those of plant, bacterial or fungal origin. Chemically modified or protein engineered mutants are included. Examples of useful peroxidases include peroxidases from Coprinus, e.g. from C. cinereus, and variants thereof as those described in WO 93/24618, WO 95/10602, and WO 98/15257. Commercially available peroxidases include Guardzyme™ and Novozym™ 51004 (Novozymes A/S).

Further enzymes suitable for use are discussed in WO 2009/087524, WO 2009/090576, WO 2009/107091, WO 2009/111258 and WO 2009/148983.

Enzyme Stabilizers

Any enzyme present in the composition may be stabilized using conventional stabilizing agents, e.g., a polyol such as propylene glycol or glycerol, a sugar or sugar alcohol, lactic acid, boric acid, or a boric acid derivative, e.g., an aromatic borate ester, or a phenyl boronic acid derivative such as 4-formylphenyl boronic acid, and the composition may be formulated as described in e.g. WO 92/19709 and WO 92/19708.

Free Perfume

The compositions of the present invention comprises free perfume.

Free perfume may be present at a level selected from: less than 20%, less than 15%, and less than 10%, by weight of the composition. Free perfume may be present at a level selected from: more than 0.5%, more than 1%, and more than 2%, by weight of the composition. Suitably free perfume is present in the composition in an amount selected from the range of from about 0.5% to about 20%, preferably from about 1% to about 15%, more preferably from about 2% to about 10%, by weight of the ancillary laundry compositions.

Useful perfume components may include materials of both natural and synthetic origin. They include single compounds and mixtures. Specific examples of such components may be found in the current literature, e.g., in Fenaroli's Handbook of Flavor Ingredients, 1975, CRC Press; Synthetic Food Adjuncts, 1947 by M. B. Jacobs, edited by Van Nostrand; or Perfume and Flavor Chemicals by S. Arctander 1969, Montclair, N.J. (USA). These substances are well known to the person skilled in the art of perfuming, flavouring, and/or aromatizing consumer products.

A wide variety of chemicals are known for perfume use including materials such as aldehydes, ketones, esters and the like. More commonly, naturally occurring plant and animal oils and exudates comprising complex mixtures of various chemical components are known for use as perfume, and such materials can be used herein. Typical perfumes can comprise e.g. woody/earthy bases containing exotic materials such as sandalwood oil, civet and patchouli oil. The perfume also can be of a light floral fragrance e.g. rose or violet extract. Further the perfume can be formulated to provide desirable fruity odours e.g. lime, lemon or orange.

Particular examples of useful perfume components and compositions are anetole, benzaldehyde, benzyl acetate, benzyl alcohol, benzyl formate, iso-bornyl acetate, camphene, cis-citral (neral), citronellal, citronellol, citronellyl acetate, paracymene, decanal, dihydrolinalool, dihydromyrcenol, dimethyl phenyl carbinol, eucalyptol, geranial, geraniol, geranyl acetate, geranyl nitrile, cis-3-hexenyl acetate, hydroxycitronellal, d-limonene, linalool, linalool oxide, linalyl acetate, linalyl propionate, methyl anthranilate, alpha-methyl ionone, methyl nonyl acetaldehyde, methyl phenyl carbinyl acetate, laevo-menthyl acetate, menthone, iso-menthone, myrcene, myrcenyl acetate, myrcenol, nerol, neryl acetate, nonyl acetate, phenyl ethyl alcohol, alpha-pinene, beta-pinene, gamma-terpinene, alpha-terpineol, beta-terpineol, terpinyl acetate, vertenex (para-tertiary-butyl cyclohexyl acetate), amyl cinnamic aldehyde, iso-amyl salicylate, beta-caryophyllene, cedrene, cinnamic alcohol, couramin, dimethyl benzyl carbinyl acetate, ethyl vanillin, eugenol, iso-eugenol, flor acetate, heliotrophine, 3-cis-hexenyl salicylate, hexyl salicylate, filial (para-tertiarybutyl-alpha-methyl hydrocinnamic aldehyde), gamma-methyl ionone, nerolidol, patchouli alcohol, phenyl hexanol, beta-selinene, trichloromethyl phenyl carbinyl acetate, triethyl citrate, vanillin, veratraldehyde, alpha-cedrene, beta-cedrene, C15H24sesquiterpenes, benzophenone, benzyl salicylate, ethylene brassylate, galaxolide (1,3,4,6,7,8-hexahydro-4,6,6,7,8,8,-hexamethyl-cyclo-penta-gamma-2-benzopyran), hexyl cinnamic aldehyde, lyral (4-(4-hydroxy-4-methyl pentyl)-3-cyclohexene-10-carboxaldehyde), methyl cedrylone, methyl dihydro jasmonate, methyl-beta-naphthyl ketone, musk ambrette, musk idanone, musk ketone, musk tibetine, musk xylol, aurantiol and phenylethyl phenyl acetate.

The free perfume compositions of the present compositions comprise blooming perfume ingredients. Blooming perfume components are defined by a boiling point less than 250° C. and a Log P or greater than 2.5. Preferably the free perfume compositions of the present invention comprise at least 10 w. % blooming perfume ingredients, more preferably at least 20 wt. % blooming perfume ingredients, most preferably at least 25 wt. % blooming perfume ingredients. Preferably the free perfume compositions of the present comprise less than 58 wt. % blooming perfume ingredients, more preferably less than 50 wt. % blooming perfume ingredients, most preferably less than 45 wt. % blooming perfume ingredients. Suitably the free perfume compositions of the present compositions comprise 10 to 58 wt. % blooming perfume ingredients, preferably 20 to 50 wt. % blooming perfume ingredients, more preferably 25 to 45 wt. % blooming perfume ingredients.

Examples of suitable blooming perfume ingredient include: Allo-ocimene, Allyl heptanoate, trans-Anethole, Benzyl butyrate, Camphene, Carvacrol, cis-3-Hexenyl tiglate, Citronellol, Citronellyl acetate, Citronellyl nitrile, Cyclohexylethyl acetate, Decyl Aldehyde (Capraldehyde), Dihydromyrcenol, Dihydromyrcenyl acetate, 3,7-Dimethyl-1-octanol, Fenchyl Acetate, Geranyl acetate, Geranyl formate, Geranyl nitrile, cis-3-Hexenyl isobutyrate, Hexyl Neopentanoate, Hexyl tiglate, alpha-Ionone, Isobornyl acetate, Isobutyl benzoate, Isononyl acetate, Isononyl alcohol, Isopulegyl acetate, Lauraldehyde, Linalyl acetate, Lorysia, D-limonene, Lymolene, (−)-L-Menthyl acetate, Methyl Chavicol (Estragole), Methyl n-nonly acetaldehyde, Methyl octyl acetaldehyde, Beta-Myrcene, Neryl acetate, Nonyl acetate, Nonaldehyde, Para-Cymene, alpha-Pinene, beta-Pinene, alpha-Terpinene, gamma-Terpinene, Terpineolene, alpha-Terpinyl acetate, Tetrahydrolinalool, Tetrahydromyrcenol, 2-Undecenal, Verdox (o-t-Butylcyclohexyl acetate), and Vertenex(4-tert.Butylcyclohexyl acetate).

Other useful perfume ingredients include substantive perfume components. Substantive perfume components are defined by a boiling point greater than 250° C. and a Log P greater than 2.5. Preferably the free perfume composition further comprises substantive perfume ingredients.

Boiling point is measured at standard pressure (760 mm Hg). Preferably a perfume composition will comprise a mixture of blooming and substantive perfume components. The perfume composition may comprise other perfume components.

The log P of many perfume ingredients have been reported; for example, the Pomona92 database, available from Daylight Chemical Information Systems, Inc. (Daylight CIS), Irvine, Calif., contains many, along with citations to the original literature. However, the log P values are most conveniently calculated by the “CLOGP” program, also available from Daylight CIS. This program also lists experimental log P values when they are available in the Pomona92 database. The “calculated log p” (Clog P) is determined by the fragment approach of Hansch and Leo (cf., A Leo, in Comprehensive Medicinal Chemistry, Vol. 4, C. Hansch, P. G. Sammens, J. B. Taylor and C. A. Ramsden, Eds., p. 295, Pergamon Press, 1990, incorporated herein by reference). The fragment approach is based on the chemical structure of each perfume ingredient, and takes into account the numbers and types of atoms, the atom connectivity, and chemical bonding. The Clog P values, which are the most reliable and widely used estimates for this physicochemical property, are used instead of the experimental log P values in the selection of perfume ingredients herein.

It is commonplace for a plurality of perfume components to be present in a free oil perfume composition. In the compositions for use in the present invention it is envisaged that there will be three or more, preferably four or more, more preferably five or more, most preferably six or more different perfume components. An upper limit of 300 perfume components may be applied.

The free perfume of the present invention is in the form of an emulsion. The particle size of the emulsion can be in the range from about 1 nm to 30 microns and preferably from about 100 nm to about 20 microns. The particle size is measured as a volume mean diameter, D[4,3], this can be measured using a Malvern Mastersizer 2000 from Malvern instruments.

Free oil perfume forms an emulsion in the present compositions. The emulsions may be formed outside of the composition or in situ. When formed in situ, at least one emulsifier is preferably added with the free oil perfume to stabilise the emulsion. Preferably the emulsifier is anionic or non-ionic. Examples suitable anionic emulsifiers for the free oil perfume are alkylarylsulphonates, e.g., sodium dodecylbenzene sulphonate, alkyl sulphates e.g., sodium lauryl sulphate, alkyl ether sulphates, e.g., sodium lauryl ether sulphate nEO, where n is from 1 to 20 alkylphenol ether sulphates, e.g., octylphenol ether sulphate nEO where n is from 1 to 20, and sulphosuccinates, e.g., sodium dioctylsulphosuccinate. Examples of suitable nonionic surfactants used as emulsifiers for the free oil perfume are alkylphenol ethoxylates, e.g., nonylphenol ethoxylate nEO, where n is from 1 to 50, alcohol ethoxylates, e.g., lauryl alcohol nEO, where n is from 1 to 50, ester ethoxylates, e.g., polyoxyethylene monostearate where the number of oxyethylene units is from 1 to 30 and PEG-40 hydrogenated castor oil. Any non-ionic surfactant included in the free perfume is counted in the overall non-ionic surfactant amount.

Encapsulated Perfume

The ancillary laundry composition of the present invention preferably comprise encapsulated perfumes. These may also be referred to as perfume microcapsules. The ancillary laundry compositions preferably comprise 0.1 to 20 wt. % by weight of the composition, perfume microcapsules, more preferably 0.5 to 12 wt. % perfume microcapsules, most preferably 1 to 8 wt. % perfume microcapsules. The weight of microcapsules is of the material as supplied.

When perfume components are encapsulated, suitable encapsulating materials, may comprise, but are not limited to; aminoplasts, proteins, polyurethanes, polyacrylates, polymethacrylates, polysaccharides, polyamides, polyolefins, gums, silicones, lipids, modified cellulose, polyphosphate, polystyrene, polyesters or combinations thereof.

Particularly preferred materials are aminoplast microcapsules, such as melamine formaldehyde or urea formaldehyde microcapsules.

Perfume microcapsules of the present invention can be friable microcapsules and/or moisture activated microcapsules. By friable, it is meant that the perfume microcapsule will rupture when a force is exerted. By moisture activated, it is meant that the perfume is released in the presence of water. The ancillary laundry compositions of the present invention preferably comprises friable microcapsules. Moisture activated microcapsules may additionally be present. Examples of a microcapsules which can be friable include aminoplast microcapsules.

Perfume components contained in a microcapsule may comprise odiferous materials and/or pro-fragrance materials.

Particularly preferred perfume components contained in a microcapsule are blooming perfume components and substantive perfume components. Blooming perfume components are defined by a boiling point less than 250° C. and a Log P greater than 2.5. Substantive perfume components are defined by a boiling point greater than 250° C. and a Log P greater than 2.5. Boiling point is measured at standard pressure (760 mm Hg). Preferably a perfume composition will comprise a mixture of blooming and substantive perfume components. The perfume composition may comprise other perfume components.

It is commonplace for a plurality of perfume components to be present in a microcapsule. In the compositions for use in the present invention it is envisaged that there will be three or more, preferably four or more, more preferably five or more, most preferably six or more different perfume components in a microcapsule. An upper limit of 300 perfume components may be applied.

The microcapsules may comprise perfume components and a carrier for the perfume ingredients, such as zeolites or cyclodextrins.

Non-Ionic Surfactant

The ancillary laundry compositions of the present invention preferably comprise less than 12 wt. % by weight of the ancillary laundry composition, more preferably less than 8 wt. % and most preferably less than 5 wt. % non-ionic surfactant. The ancillary laundry compositions of the present invention preferably comprise more than 0.5 wt. % non-ionic surfactant. Suitably, the ancillary laundry compositions of the present invention preferably comprise 0.5 to 12 wt. %, more preferably 0.5 to 8 wt. % and most preferably 0.5 to 5 wt. % non-ionic surfactant. The correct amount of non-ionic surfactant is important to achieve the desired delivery of the benefit agent. The ancillary laundry composition requires sufficient surfactant to carry the benefit agent, however too much surfactant will interfere with the action of the laundry liquid or powder with which it is used and will prevent release of the benefit agent due to insufficient dilution.

The non-ionic surfactants will preferably have an HLB value of 12 to 20, more preferably 14 to 18.

Examples of non-ionic surfactant materials include: ethoxylated materials, polyols such as polyhydric alcohols and polyol esters, alkyl polyglucosides, EO-PO block copolymers (Poloxamers). Preferably, the non-ionic surfactant is selected from ethoxylated materials.

Preferred ethoxylated materials include: fatty acid ethoxylates, fatty amine ethoxylates, fatty alcohol ethoxylates, nonylphenol ethoxylates, alkyl phenol ethoxylate, amide ethoxylates, Sorbitan(ol) ester ethoxylates, glyceride ethoxylates (castor oil or hydrogenated castor oil ethoxylates) and mixtures thereof.

More preferably, the non-ionic surfactant is selected from ethoxylated surfactants having a general formula:

R₁O(R₂O)ₓH

R₁=hydrophobic moiety.

R₂═C₂H₄ or mixture of C₂H₄ and C₃H₆ units

x=4 to 120

R1 preferably comprises 8 to 25 carbon atoms and mixtures thereof, more preferably 10 to 20 carbon atoms and mixtures thereof most preferably 12 to 18 carbon atoms and mixtures thereof. Preferably, R is selected from the group consisting of primary, secondary and branched chain saturated and/or unsaturated hydrocarbon groups comprising an alcohol, carboxy or phenolic group. Preferably R is a natural or synthetic alcohol.

R2 preferably comprises at least 50% C2H4, more preferably 75% C2H4, most preferably R2 is C2H4.

x is preferably 8 to 90 and most preferably 10 to 60.

Examples of commercially available, suitable non-ionic surfactants include: Genapol C200 ex. Clariant and Eumulgin CO40 ex. BASF.

Other Surfactants

The ancillary laundry composition of the present invention is not a traditional laundry detergent or fabric conditioning composition. The present invention preferably comprises low levels or no anionic or cationic surfactant.

The liquid ancillary composition of the present invention preferably comprises less than 2 wt. % by weight of the composition, anionic and cationic surfactant, more preferably less than 1 wt. % surfactant, even more preferably less than 0.85 wt. % anionic and cationic surfactant and most preferably less than 0.5 wt. % anionic and cationic surfactant.

The composition can be completely free of anionic and cationic surfactants.

In other words, the compositions preferably comprise 0 to 2 wt. % by weight of the composition, anionic and cationic surfactant, more preferably, 0 to 1 wt. % anionic and cationic surfactant, even more preferably 0 to 0.85 wt. % and most preferably 0 to 0.5 wt. % anionic and cationic surfactant. The composition can be completely free of anionic and cationic surfactant.

Structurants

If the ancillary laundry composition comprises microcapsules, a structurant may be required, non-limiting examples of suitable structurants include: pectine, alginate, arabinogalactan, carageenan, gellan gum, polysaccharides such as xanthum gum, guar gum, acrylates/acrylic polymers, water-swellable clays, fumed silicas, acrylate/aminoacrylate copolymers, and mixtures thereof.

Preferred dispersants herein include those selected from the group consisting of acrylate/acrylic polymers, gellan gum, fumed silicas, acrylate/aminoacrylate copolymers, water-swellable clays, polysaccharides such as xanthum gum and mixtures thereof. Most preferably the structurant is selected from polysaccharides such as xanthum gum, acrylate/acrylic polymers, acrylate/aminoacrylate copolymers, and water-swellable clays. Most preferred structurants are polysaccharides such as xanthum gum.

When present, a structurant is preferably present in an amount of 0.001-10 wt. % of the composition, preferably from 0.005-5 wt. %, more preferably 0.01-3 wt. %.

Rheology Modifier

In some embodiments of the present invention, the ancillary laundry composition of the present invention may comprise rheology modifiers. These may be inorganic or organic, polymeric or non polymeric. A preferred type of rheology modifiers are salts.

Preservatives

The ancillary laundry composition of the present invention preferably comprises preservatives. Preservatives are preferably present in an amount of 0.001 to 1 wt. % of the composition. More Preferably 0.005 to 0.5 w.t %, most preferably 0.01 to 0.1 wt. % of the composition.

Preservatives can include anti-microbial agents such as isothiazolinone-based chemicals (in particular isothiazol-3-one biocides) or glutaraldehyde-based products. Examples of suitable preservatives include Benzisothiazoline, Cloro-methyl-isothiazol-3-one, Methyl-isothiazol-3-one and mixtures thereof. Suitable preservatives are commercially available as Kathon CG ex. Dow and Proxel ex Lonza.

Other Ingredients

The ancillary laundry composition of the present invention may comprise further benefit agents. Examples of suitable further benefit agents include:
silicone oils, resins, emulsions and modifications thereof such as linear and cyclic polydimethylsiloxanes, amino-modified, alkyl, aryl, and alkylaryl silicone oils
malodour agents for example: uncomplexed cyclodextrin; odor blockers; reactive aldehydes; flavanoids; zeolites; activated carbon; and mixtures thereof
dye transfer inhibitors
shading dyes
fluorescent agents/optical brighteners
insect repellents
organic sunscreen actives, for example, octylmethoxy cinnamate;
antimicrobial agents, for example, 2-hydroxy-4, 2,4-trichlorodiphenylether;
ester solvents; for example, isopropyl myristate;
anti redeposition agents
lipids and lipid like substance, for example, cholesterol;
hydrocarbons such as paraffins, petrolatum, and mineral oil
fish and vegetable oils;
hydrophobic plant extracts;
waxes;
pigments including inorganic compounds with hydrophobically-modified surface and/or dispersed in an oil or a hydrophobic liquid;
sugar-esters, such as sucrose polyester (SPE);

and combinations thereof.

Preferred further benefit agents may be selected from: silicones, malodour agents, dye transfer inhibitors, fluorescent agents/optical brighteners, shading dyes, anti-microbials.

Examples of suitable silicones for the present invention are fabric softening silicones. Non-limiting examples of such silicones include:
Non-functionalised silicones such as polydimethylsiloxane (PDMS),
Functionalised silicones such as alkyl (or alkoxy) functionalised, alkylene oxide functionalised, amino functionalised, phenyl functionalised, hydroxy functionalised, polyether functionalised, acrylate functionalised, siliconhydride functionalised, carboxy functionalised, phosphate functionalised, sulphate functionalised, phosphonate functionalised, sulphonic functionalised, betaine functionalised, quarternized nitrogen functionalised and mixtures thereof.
Copolymers, graft co-polymers and block co-polymers with one or more different types of functional groups such as alkyl, alkylene oxide, amino, phenyl, hydroxy, polyether, acrylate, siliconhydride, carboxy, phosphate, sulphonic, phosphonate, betaine, quarternized nitrogen and mixtures thereof.

The products of the invention may further comprise other optional laundry ingredients known to the person skilled in the art, such as antifoams, insect, pH buffering agents, perfume carriers, hydrotropes, polyelectrolytes, anti-oxidants, dyes, colorants, sunscreens, anti-corrosion agents and sequestrants. The products of the invention may contain pearlisers and/or opacifiers.

The compositions of the present invention are aqueous compositions and comprise water.

Viscosity

The viscosity of the ancillary laundry composition is preferably 20-15000 mPa·s, more preferably 50 to 15000 mPa·s, most preferably 100 to 10000 mPa·s. This viscosity provides the benefit that the laundry liquid carries the ancillary laundry composition into the laundry process.

Throughout this specification viscosity measurements were carried out at 25° C., using a 4 cm diameter 2° cone and plate geometry on a DHR-2 rheometer ex. TA instruments.

In detail, all measurements were conducted using a TA-Instruments DHR-2 rheometer with a 4 cm diameter 2 degree angle cone and plate measuring system. The lower Peltier plate was used to control the temperature of the measurement to 25° C. The measurement protocol was a ‘flow curve’ where the applied shear stress is varied logarithmically from 0.01 Pa to 400 Pa with 10 measurement points per decade of stress. At each stress the shear strain rate is measured over the last 5 seconds of the 10 second period over which the stress is applied with the viscosity at that stress being calculated as the quotient of the shear stress and shear rate.

For those systems which exhibit a low shear viscosity plateau over large shear stress ranges, to at least 1 Pa, the characteristic viscosity is taken as being the viscosity at a shear stress of 0.3 Pa. For those systems where the viscosity response is shear thinning from low shear stress the characteristic viscosity is taken as being the viscosity at a shear rate of 21 s−1.

Preferably, the ancillary laundry composition floats on a, laundry liquid with which it is used. By float it is meant that the ancillary laundry composition will remain at the surface of the laundry liquid for a period of at least 5 minutes, preferably 10 minutes and most preferably at least 15 minutes. Floating provides the benefit the laundry liquid carries the ancillary laundry composition into the laundry process.

To enable the ancillary laundry composition to float, it is not essential that it is less dense than the laundry liquid with which it is being used, however it is preferred that the ancillary laundry composition is less dense than the laundry liquid with which it is used. This density provides the benefit the laundry liquid carries the ancillary laundry composition into the laundry process.

The ancillary laundry composition is preferably not miscible with a laundry liquid with which it is used. The in-admissibility prevents mixing of the ancillary laundry composition and laundry liquid and ensures maximum performance.

Multi-Wash

The ancillary laundry compositions of the present invention are designed to be used in multiple consecutive washes. The benefits from using the ancillary laundry compositions of the present invention may be cumulative over a number of washes. In particular, 5 or more washes, preferably 10 or more washes, more preferably 15 or more washes and most preferably 20 or more washes.

Method

The ancillary laundry composition is intended to be used in addition to a fabric conditioner formulation. By fabric conditioners is meant a formulation designed to soften fabrics in the rinse stage of the laundry process. Fabric conditioner compositions generally comprise 2-25 wt. % fabric softening active. A preferred fabric softening active is a quaternary ammonium surfactant.

In one aspect of the present invention is provided a method of delivering enzymes to fabrics during the rinse stage of the laundry cycle, wherein an ancillary laundry composition as described herein is added to the rinse, in addition to a fabric conditioner formulation.

By added to the rinse, is meant that the formulation is added to the rinse liquor, in the rinse stage of the laundry process.

In another aspect of the present invention is provided a method of improving the softening benefit of a fabric conditioner, wherein an ancillary laundry composition as described herein is added to the rinse, in addition to a fabric conditioner formulation.

A preferred method for either of the above methods include:
a. Pouring a fabric conditioner formulation into a washing receptacle, a washing machine drawer, or a dosing shuttle
b. Pouring an ancillary laundry composition as described herein on top of the laundry product.

By washing receptacle, it is meant any vessel in which washing is performed. This may be for example the drum of a front or top loading washing machine or a bowl/sink in which hand washing is performed. By drawer it as meant any one of the compartments in the washing machine drawer. By dosing ball is meant any form of container which would usually hold a laundry detergent composition and be placed directly in a washing machine.

Preferably a fabric conditioner is poured into a washing machine drawer or a dosing ball, and then the ancillary laundry composition is poured on top of the laundry product in the drawer or dosing ball. Pouring the ancillary laundry composition on top of the laundry product provides the benefit that a the fabric conditioner carries the ancillary laundry composition into the wash or rinse without mixing with the two compositions.

Although the primary purpose of the ancillary rinse composition described herein, is to be used in the rinse stage of the wash, in addition to a fabric conditioning formulation, it may also be used in the main wash stage of the laundry process. The ancillary laundry composition may be used in a method of delivering enzymes to fabrics, wherein the ancillary laundry composition is added to the main wash, followed by the addition to a fabric conditioner formulation in the rinse. This would provide a method of improving the softening benefit of a fabric conditioner, wherein the ancillary laundry composition is added to the main wash, followed by the addition of a fabric conditioner formulation in the rinse.

Preferably the ancillary laundry composition is added to the laundry process in a volume of 2-50 ml, preferably 2-30 ml, most preferably 2-20 ml. This dose is typically used with a 4-8 kg load of fabric, preferably and 5-6 kg load of fabric.

Use

In one embodiment of the present invention is provided the use of an ancillary laundry composition described herein, to deliver enzymes to fabrics in the rinse stage of the laundry cycle.

In another embodiment of the present invention is provided the use of an ancillary laundry composition described herein, to improve the softening benefit of a fabric conditioner. The improved softening may be measured by a panel test or by suitable apparatus.

Example Compositions

TABLE 1
Example composition of the present invention

| Ingredient | 1 (wt. %) | 2 (wt. %) |
|---|---|---|
| Non-ionic surfactant¹ | 3 | 5 |
| Cellulase | 0.0001 | 0.1 |
| Free perfume | 10 | 8 |
| Encapsulated perfume | — | 4 |
| Water | To 100 | To 100 |

Non-ionic surfactant¹Eumulgin CO40 ex. BASF
These compositions provide improved softening.

1) A rinse added ancillary laundry composition, for improving the softening effect of a fabric conditioner, the ancillary laundry composition comprising:
a. cellulase;
b. 0.5 to 12 wt. % non-ionic surfactant;
c. 0.5 to 20 wt. % free perfume; and
d. water;
wherein the composition comprises less than 2 wt. % anionic and/or cationic surfactant.

2) The ancillary laundry composition according to claim 1, wherein the composition further comprises 0.1 to 20 wt. % encapsulated perfume.

3) The ancillary laundry composition according to claim 1, wherein the non-ionic surfactant comprises ethoxylated non-ionic surfactant.

4) The ancillary laundry composition according to claim 1, wherein the composition further comprises a structurant.

5) The ancillary laundry composition according to claim 1, wherein the ancillary laundry composition has a viscosity of 20-15000 mPa·s.

6) A method of delivering enzymes to fabrics during a rinse stage of a laundry cycle, wherein the ancillary laundry composition according to claim 1, is added to a rinse, in addition to a fabric conditioner formulation.

7) A method of improving a softening benefit of a fabric conditioner, wherein the ancillary laundry composition according to claim 1, is added to a rinse, in addition to a fabric conditioner formulation.

8) A method of delivering enzymes to fabrics during a wash stage of a laundry cycle, wherein the ancillary laundry composition according to claim 1, is added to the wash stage of the laundry cycle, followed by addition of a fabric conditioner formulation in a rinse.

9) A method of improving a softening benefit of a fabric conditioner, wherein the ancillary laundry composition according to claim 1, is added to a wash stage of a laundry process, followed by addition of a fabric conditioner formulation in a rinse.

10) (canceled)

11) (canceled)
